(19) United States
(12) Patent Application Publication
(10) Pub. No.: US 2025/0352832 A1
(43) Pub. Date: Nov. 20, 2025

(54) EMERGENCY CUT-DOWN TOOL

(71) Applicant: First Tactical, LLC, Modesto, CA (US)

(72) Inventor: Cory Nykoluk, Oakdale, CA (US)

(21) Appl. No.: 19/207,968

(22) Filed: May 14, 2025

Related U.S. Application Data
(60) Provisional application No. 63/647,420, filed on May 14, 2024.

(51) Int. Cl. A62B 3/00

(52) U.S. Cl. CPC A62B 3/00

(57) ABSTRACT

A cut-down rescue tool, particularly for use in prisons, has a handle and a hook-shaped head that carries an interior curved cutting edge. Clearance into the cutting region is sufficiently large as to enable the tool to engage over a prisoner-fabricated hanging noose such as a braided bed sheet or clothing. The tool is integrally formed with a single piece of steel so that multiple assembled parts and replacement blades are avoided. The handle of the tool is ergonomically shaped for comfortable and efficient gripping and use.

### CROSS REFERENCE TO RELATED APPLICATIONS

This application claims the benefit of U.S. Provisional Application No. 63/647,420 filed on May 14, 2024.

### FIELD OF THE INVENTION

The present invention relates to safety and rescue gear, and in particular a manual cut-down tool particularly for suicide rescue.

### BACKGROUND OF THE INVENTION

A large number of different configurations of knives have been available to enable emergency personnel to quickly cut through seat belts or ropes, and there have also been several tools carried by prison guards for the purpose of cutting through a braided sheet of clothing used in an attempted hanging suicide. Typically, tools used by prison facilities for this purpose are more suitable for seat belts than hanging rescue, in that the opening into the hook-shaped head of such a tool is not sufficiently wide to engage over braided sheets or clothing as often used in an attempted prison hanging suicide.

The typical hook shaped cutting head, with sharp blade in the interior of the hook, provides for safe and effective cutting through seat belts after an accident, without the risk of injury or damage to a person or anything else which might be under the object being cut. The general hooked shape also prevents use of such a cut-down tool as a weapon, which is important in prisons. This hooked shaped feature is also included in the current invention.

Another issue with many prior cut-down knives or seat belt cutters is that they are formed of several pieces, one of which is often a replaceable blade. Multiple components present a hazard in a prison setting, in that replacement blades are sometimes needed and may be carried by a guard and somehow fall into the hands of a prisoner. Even a multi-component assembled tool without replacement blades could potentially be dismantled to form a weapon with the blade end of the tool.

Tools that have been used in corrections facilities for hanging suicide rescue include “911 Rescue Tool Corrections Cut Down Knife Seat Belt Cutter”, marketed by National Duty Supply (nationaldutysupply.com/accessories); and “Gerber Vital Zip” marketed by Scheels (www.scheels.com).

Other tools, usually styled as seat belt cutters, include “RNR Talon Rescue Hook Knife,” marketed by RNR; “Colombia River CRKT Kert/Key Ring Emergency Rescue Tool,” marketed by Colombia River; and “Titanium Line Cutter” marketed by Dive Right in Scuba.

### SUMMARY OF THE INVENTION

A rescue cut-down tool of the invention has an integrally formed tool body. In some embodiments, the entire tool, including the cutting blade, being formed of a single piece of steel. The body includes a handle and a hooked head that forms an internally curving interior side within which the integrally formed cutting edge is located. In some embodiments, the tool has a minimum clearance for engaging over a rope or home-made noose device of preferably about 9/16 inch, i.e., about 0.56 inch. This clearance is suitable to engage over a twisted or braided sheet or clothing.

In some embodiments, the tool includes an opening at the upper end of the handle for an index finger, this opening being just above a hand grip for engagement by the fingers and palm. In some embodiments, the tool includes a serrated, roughened, or ridged surface on its back edge, near the finger hole, for secure thumb engagement and working leverage along with the index finger hole. Accordingly, the tool is easily gripped and ergonomically shaped for quick action in an emergency.

In some embodiments, the tool of the invention can include holes in the handle to facilitate wrapping of a lace, such as a leather thong, around outer portions of the handle, and also a tethering cord can be attached via these holes.

The above features and others described below serve the objective of a tool particularly for use in a corrections facility, secure in being formed of a single piece and capable of engaging the hooked cutting edge over a relatively large object such as a braided sheet or clothing. The tool is also useful to cut through seat belts and can be used in other rescue situations. Other objects and features will be apparent from the following description of a preferred embodiment, considered along with the accompanying drawings.

### DESCRIPTION OF THE DRAWINGS

Those of skill in the art will recognize that the following description is merely illustrative of the principles of the disclosure, which may be applied in many ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given herein and the detailed description of the drawings given below, explain the principles of the disclosure.

FIG. 1 is a side view showing the tool.

FIG. 2 is an edge or profile view of the tool.

FIG. 3 is a side view of the tool as fitted with lace around the handle and as a tether and cord.

FIG. 4 is a front view of a pouch for carrying the tool, the pouch being adapted for MOLLE attachment to a backpack or tactical gear.

FIG. 5 is a side view of a pouch for carrying the tool, the pouch being adapted for MOLLE attachment to a backpack or tactical gear.

FIG. 6 is a back view of a pouch for carrying the tool, the pouch being adapted for MOLLE attachment to a backpack or tactical gear.

FIG. 7 shows the pouch in a frontal view, with the tool carried in the pouch.

Like reference numerals refer to like parts throughout the several views of the drawings. The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant's intent that this specification and the claims appended hereto be accorded with breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, embodiments of the system are disclosed for the purpose of illustrating the nature of the invention. The embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

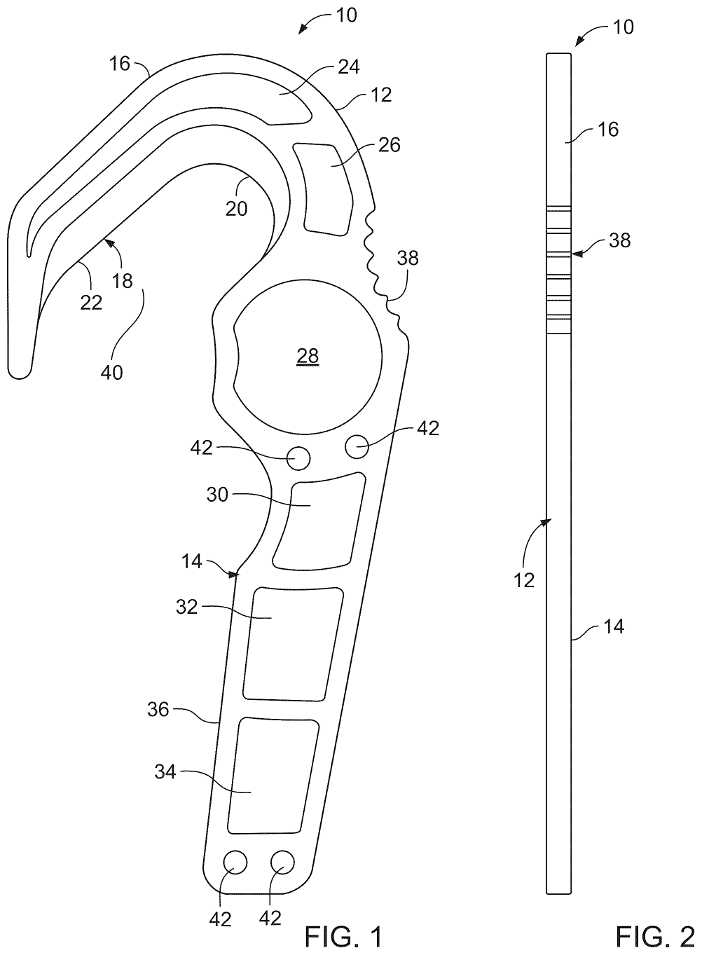

As used herein, the words or phrase “in some embodiments,” “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” “distal,” “proximal” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 1 shows the cut-down rescue tool 10 of the invention, comprising a unitary body 12 that includes a handle 14 and a hook-shaped head 16. In some embodiments, the body 12 comprises steel or other corrosion-resistant material to ensure longevity and reliability in various environmental conditions. The hook-shaped head 16 includes a cutting edge 18, which in some embodiments is J-shaped as shown, with a curving, generally crescent-shaped concave back part 20 and a substantially linear (or less curved) part 22 extending from the curved back part 20. In some embodiments, the hook-shaped head 16 and cutting edge 18 are all part of the same unit of manufacture, being integral with the steel of the body 12.

In some embodiments, the tool 10 includes weight-relief cutouts at 24, 26, 28, 30, 32 and 34. In some embodiments, one of these cutouts 28 is an indexing hole which receives the index finger for a convenient, ergonomic and firm grip on the tool, while the fingers and palm engage a lower end part 36 of the handle. In some embodiments, the index finger hole has a diameter (or maximum width) of about one inch, or a range of about 13/16 inch to about 1⅛ inch. The back side of the tool preferably includes a serrated, notched, ridged, or channeled area 38 designed for pressing and gripping with the thumb when the tool is in use.

As appreciated, the tool 10 includes substantial clearance delimited by the opening 40 to the cutting edge 18. In some embodiments, this opening is at least about ½ inch across (from the distal tip of the hook-shaped head 16 to the edge of the cutout 28), or preferably at least 0.56 inch, more preferably somewhat larger, e.g., ¾ inch to 1 inch. This enables the tool to grip over large and home-made rope-function implements such as twisted or braided bed sheets or clothing, as sometimes used by prisoners in attempting a hanging suicide.

FIG. 2 shows that, in some embodiments, the tool is of thin profile. In some embodiments, the overall height of the tool is somewhat less than 4 inches, e.g., about 3.8 inches to about 4 inches, with a width of about 2.5 inches to 2.7 inches. For a tool of such size the thickness is, in some embodiments, about 0.11 inch (approximately 2.9 mm), and can be somewhat less or more.

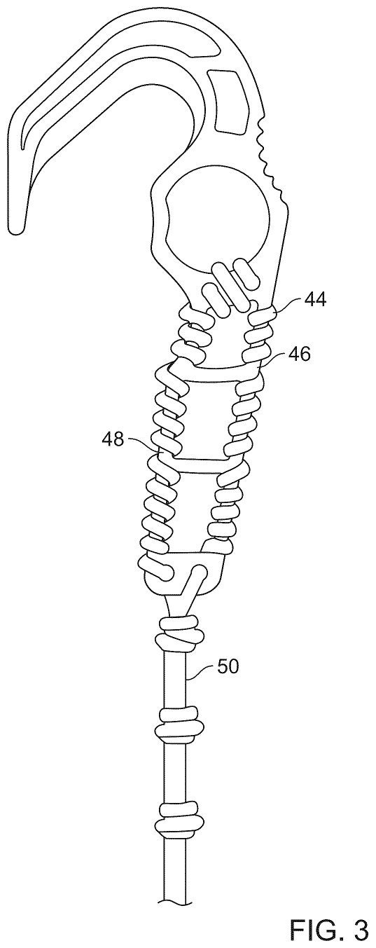

Referring back to FIG. 1, the tool handle 14 in some embodiments includes a series of small holes 42 at upper and lower locations of the handle. These can be used for installing lacing 44 on the tool, as shown in FIG. 3. Lacing can be wrapped around outer legs 46 and 48 of the handle, for additional comfort and secure gripping of the tool. Similarly, a tethering cord 50 can be attached if desired, as shown in FIG. 3, via the lower holes 42. These cords or lacing can be leather, rubbery material, rope, or other material.

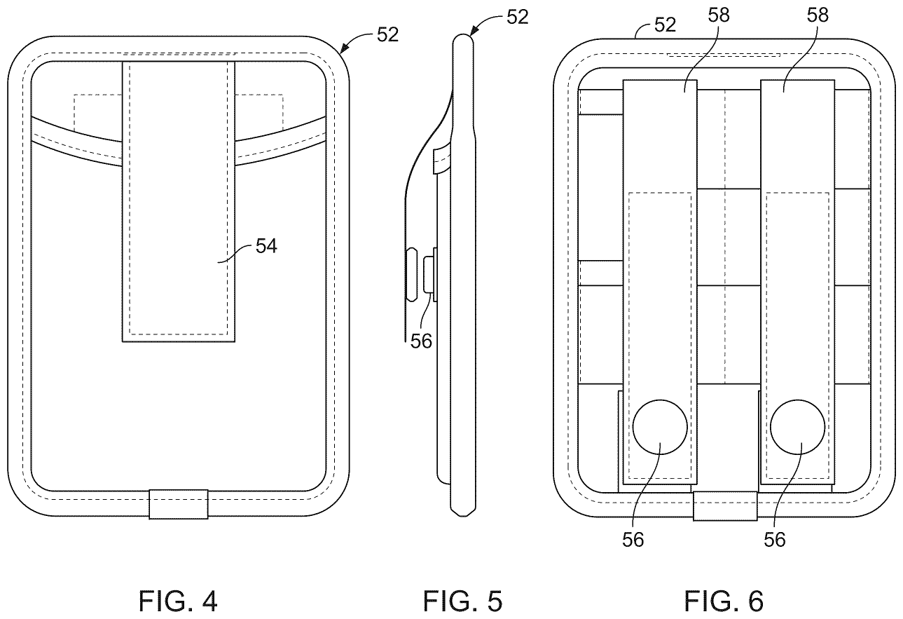

FIGS. 4 through 7 show a carrying pouch 52 which can optionally be provided for the tool of the invention. This carrying pouch is adapted for Modular Lightweight Load-carrying Equipment (MOLLE) attachment to a tactical backpack or other gear, a system well known for military and tactical use. FIG. 4 shows the front side, with a strap 54 securable by a snap 56. MOLLE straps 58 are shown at the back side, and these can also be secured by snaps 56 or other attachment, such as hook and loop fasteners.

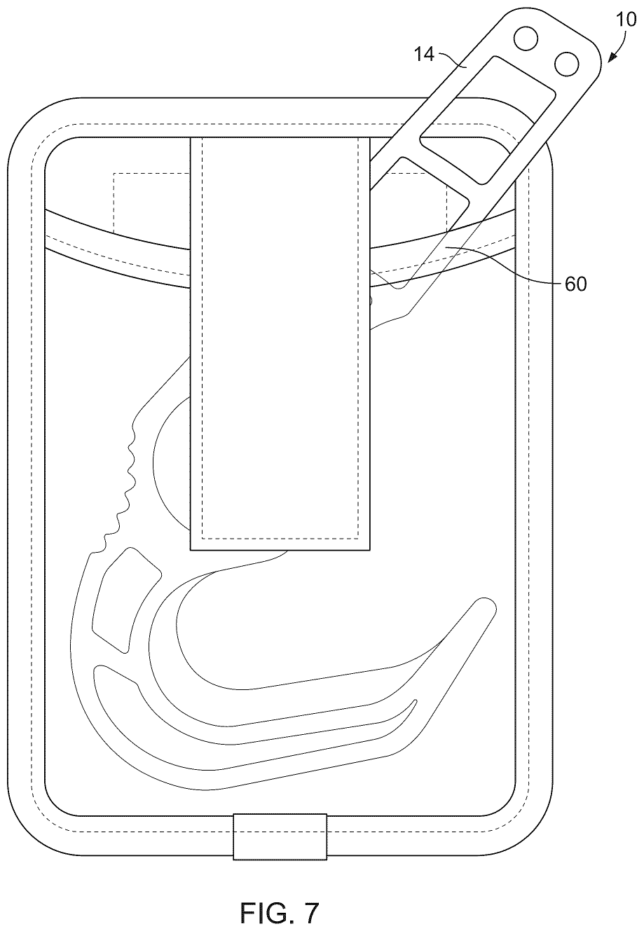

FIG. 7 shows the pouch carrying the cutting tool 10 of the invention. At the tool size outlined above, the handle will extend out slightly from an upper lip 60 of the MOLLE pouch. The handle can be oriented in either direction, left or right.

The term “about” used in regard to dimensions should be considered to mean plus or minus 12%.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in many ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing detailed description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A rescue tool, comprising:
a. a unitary body including a handle and a hook-shaped head;
b. a cutting edge positioned on the hook-shaped head, configured to cut through materials such as ropes or clothing;
c. weight-relief cutouts integrated into the unitary body to reduce the overall weight of the tool, wherein at least one weight-relief cutout comprises an indexing hole; and
d. a ridged area on the handle configured as a grip.

2. The rescue tool of claim 1, wherein the cutting edge is substantially J-shaped.

3. The rescue tool of claim 1, wherein an opening of the hook shaped head is at least about ½ inch across.

4. The rescue tool of claim 1, wherein an opening of the hook shaped head is at least about 0.56 inch across.

5. The rescue tool of claim 1, wherein an opening of the hook shaped head is at least about ¾ inch across.

6. The rescue tool of claim 1, wherein an opening of the hook shaped head is at least about 1 inch across.

7. The rescue tool of claim 1, including one or more holes adapted for receiving lacing or tethering.

8. The rescue tool of claim 1, including a carrying pouch designed for attachment to Modular Lightweight Load-carrying Equipment (MOLLE) systems.

9. The Rescue Tool of claim 1, wherein the unitary body is constructed from a corrosion-resistant material to ensure longevity and reliability in various environmental conditions.
